(19) United States
(12) Patent Application Publication
(10) Pub. No.: US 2021/0339914 A1
(43) Pub. Date: Nov. 4, 2021

(54) SQUARE-BOTTOMED PACKAGING BAG, PACKAGING BODY, AND METHOD OF MANUFACTURING SQUARE-BOTTOMED PACKAGING BAG

(71) Applicant: HOSOKAWA YOKO CO., LTD., Chiyoda-ku, Tokyo (JP)

(72) Inventors: Raizo KUGE, Chiyoda-ku, Tokyo (JP); Kazuhiro UMENAKA, Chiyoda-ku, Tokyo (JP); Sho OBARA, Koshigaya-shi, Saitama (JP)

(21) Appl. No.: 17/280,219

(22) PCT Filed: Sep. 30, 2019
(86) PCT No.: PCT/JP2019/038546

§ 371 Date: Mar. 26, 2021

(30) Foreign Application Priority Data
Oct. 1, 2018 (JP) 2018-186562

(51) Int. Cl. B65D 30/00; B65D 30/08; B31B 70/26

(52) U.S. Cl. CPC B65D 31/005; B31B 2150/001; B31B 70/266; B65D 31/02

(57) ABSTRACT

A square-bottomed packaging bag (1) of the present invention is a square-bottomed packaging bag formed by bending a one-piece soft packaging material and includes a quadrangular bottom surface (10), a front surface (20) and a rear surface (30) standing from two opposite sides of the bottom surface, and a left side surface (40) and a right side surface (50) connecting the front surface and the rear surface, in which each of the left side surface and the right side surface includes a first region (41, 51) positioned on the front surface side, a second region (42, 52) positioned on the rear surface side, and a side-surface-joining portion (43, 53) joining the first region and the second region.

### TECHNICAL FIELD

The present invention relates to a square-bottomed packaging bag, a packaging body, and a method of manufacturing the square-bottomed packaging bag.

Priority is claimed on Japanese Patent Application No. 2018-186562 filed in Japan on Oct. 1, 2018, the content of which is incorporated herein by reference.

### BACKGROUND ART

As a soft packaging container having an excellent self-standing property and a large inner volume, a square-bottomed type packaging bag including a quadrangular bottom surface and four side surfaces standing from the bottom surface (hereinafter referred to as “square-bottomed packaging bag”) is known.

Various aspects are disclosed as a structure of the square-bottomed packaging bag.

Patent Literature 1 describes a self-standing bag (square-bottomed packaging bag) in which a pair of flat surface portions, a pair of side surface portions, and a bottom surface portion are each formed of separate soft packaging materials. In a gusset bag (square-bottomed packaging bag) described in Patent Literature 2, a bottom surface portion and a flat surface portion connected to two sides of the bottom surface portion are formed by bending a one-piece soft packaging material.

In a side gusset bag (square-bottomed packaging bag) described in Patent Literature 3, a bottom surface, a front surface, a rear surface, and left and right side surfaces are formed by bending a one-piece soft packaging material.

The square-bottomed packaging bag of Patent Literature 3 does not require a step of joining soft packaging materials other than the one-piece soft packaging material at the time of manufacturing. Therefore, the square-bottomed packaging bag in which contents are filled can be manufactured by sequentially filling the contents and forming the square-bottomed packaging bag while feeding out a raw material roll of a continuous single sheet of the soft packaging material such as a plastic film.

### CITATION LIST

### Patent Literature

### Patent Literature 1

Japanese Unexamined Patent Application, First Publication No. 2002-225879

### Patent Literature 2

Japanese Unexamined Patent Application, First Publication No. 2004-189283

### Patent Literature 3

Japanese Unexamined Patent Application, First Publication No. 2001-206385

### SUMMARY OF INVENTION

### Technical Problem

In the square-bottomed packaging bag disclosed in Patent Literature 3, a ridge line portion between a front surface and a bottom surface and a ridge line portion between a rear surface and the bottom surface are formed by heat sealing. Therefore, the ridge line portion broadens in a horizontal direction when the square-bottomed packaging bag stands on its own in a store display or the like. That is, an actual area of the bottom surface portion is larger than an area of a bottom surface of a content-accommodating portion. Accordingly, display efficiency is low and an external appearance is also not satisfactory. Also, when a plurality of square-bottomed packaging bags are displayed, the ridge portions may interfere with each other and the display state may become unstable.

In view of the above circumstances, an objective of the present invention is to provide a square-bottomed packaging bag which can be formed from a one-piece soft packaging material and has a satisfactory external appearance, and a method of manufacturing the same.

### Solution to Problem

A first aspect of the present invention is a square-bottomed packaging bag formed by bending a one-piece soft packaging material and the square-bottomed packaging bag includes a quadrangular bottom surface, a front surface and a rear surface standing from two opposite sides of the bottom surface, and a left side surface and a right side surface connecting the front surface and the rear surface, in which each of the left side surface and the right side surface includes a first region positioned on the front surface side, a second region positioned on the rear surface side, and a side-surface-joining portion joining the first region and the second region.

In the first aspect of the present invention, the front surface and the first region may be continuous with each other via one side seal portion in which the front surface and the first region are joined by a constant width, and the rear surface and the second region may be continuous with each other via another side seal portion, in which the rear surface and the second region are joined by a constant width, different from the one side seal portion.

In the first aspect of the present invention, the side-surface-joining portion may be a butt-joint seal portion in which inner surfaces of the first region and the second region are joined to each other.

The square-bottomed packaging bag according to the first aspect of the present invention may further include, on a circumferential edge of the bottom surface, a lower end seal portion which goes along lower ends of the front surface, the left side surface, the rear surface, and the right side surface in a circumferential direction.

A second aspect of the present invention is a packaging body including the square-bottomed packaging bag according to the first aspect of the present and contents filled inside the square-bottomed packaging bag.

A third aspect of the present invention is a method of manufacturing a square-bottomed packaging bag using a one-piece soft packaging material, and the method of manufacturing a square-bottomed packaging bag includes a bottom surface folding step of forming a flat state in which a region to become a bottom surface folded in an inverted V shape is positioned between a region to become a front surface and a region to become a rear surface by mountain-folding the soft packaging material along a first fold line such that the soft packaging material is folded in half and valley-folding the soft packaging material along two second fold lines that are parallel to the first fold line and positioned equidistant from the first fold line, and a side surface forming step of joining regions to become first regions positioned on two sides of the region to become the front surface to regions to become second regions positioned on two sides of the region to become the rear surface.

The method of manufacturing a square-bottomed packaging bag of the third aspect of the present invention may further include, before the bottom surface folding step, a side seal portion and bottom seal portion forming step in which folded-back portions are formed on outward sides of boundary lines in a left-right direction, the boundary lines being positioned between the region to become the front surface and the regions to become the first regions, and between the region to become the rear surface and the regions to become the second regions, by valley-folding the soft packaging material along the boundary lines and by mountain-folding the soft packaging material along folded-back lines substantially parallel to the boundary lines, and side seal portions and bottom seal portions are formed on two sides in the left-right direction of the region to become the front surface and the region to become the rear surface by joining heat fusion layers of each of the folded-back portions.

### Advantageous Effects of Invention

According to the present invention, the square-bottomed packaging bag which can be formed of a one-piece soft packaging material and has a satisfactory external appearance can be provided.

### BRIEF DESCRIPTION OF DRAWINGS

FIG. 1 is a perspective view illustrating a square-bottomed packaging bag according to a first embodiment of the present invention.

FIG. 2 is a schematic cross-sectional view along line 14 of FIG. 1.

FIG. 3 is a partial perspective view illustrating the inside of the same square-bottomed packaging bag according to the first embodiment of the present invention.

FIG. 4 is a schematic cross-sectional view of a film.

FIG. 5 is a developed view of the same square-bottomed packaging bag according to the first embodiment of the present invention.

FIG. 6A is a view illustrating one step of a method of manufacturing a square-bottomed packaging bag according to the first embodiment of the present invention.

FIG. 6B is a view illustrating a modified example of one step of the method of manufacturing a square-bottomed packaging bag according to the first embodiment of the present invention.

FIG. 7 is a view one step of the same method of manufacturing the square-bottomed packaging bag.

FIG. 8 is a view illustrating one step of the same method of manufacturing the square-bottomed packaging bag.

FIG. 9 is a cross-sectional view of a folded-back portion of the same square-bottomed packaging bag of a modified example.

FIG. 10 is a perspective view illustrating the same square-bottomed packaging bag of the modified example.

FIG. 11 is a view of the same square-bottomed packaging bag of the modified example from a bottom side.

FIG. 12 is a perspective view illustrating a square-bottomed packaging bag according to a second embodiment of the present invention.

FIG. 13 is a developed view of the same square-bottomed packaging bag according to the second embodiment of the present invention.

FIG. 14 is a perspective view illustrating a square-bottomed packaging bag according to a third embodiment of the present invention.

FIG. 15 is a view of the same square-bottomed packaging bag according to the third embodiment of the present invention from a bottom side.

FIG. 16 is a view illustrating an example of a left side surface with which a butt-joint seal portion is integrated.

FIG. 17 is a view illustrating another example of the developed view.

### DESCRIPTION OF EMBODIMENTS

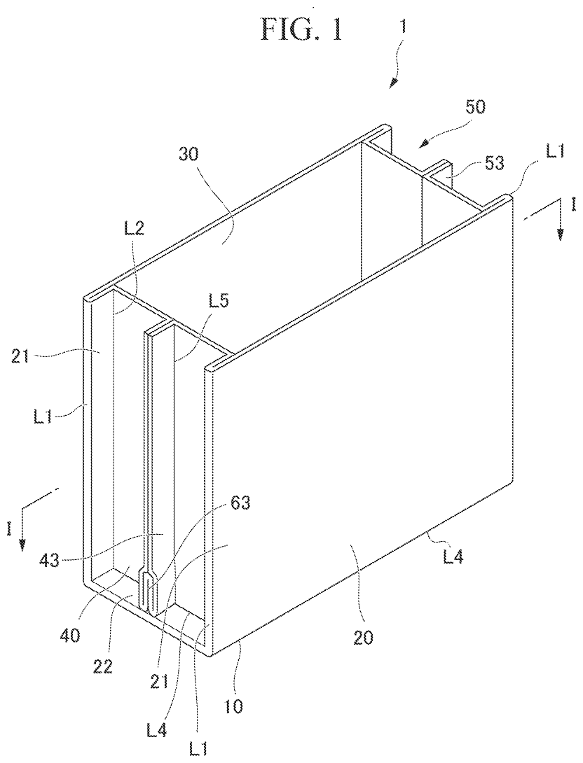

A first embodiment of the present invention will be described with reference to FIGS. 1 to 11.

FIG. 1 is a perspective view illustrating a square-bottomed packaging bag 1 of the present embodiment and illustrates a state f the square-bottomed packaging bag 1 before contents are filled. The square-bottomed packaging bag 1 is formed from a one-piece film (soft packaging material) only by bending and joining. In the following description, a side of the square-bottomed packaging bag 1 on which an upper opening is provided may be referred to as an upper side, and a side opposite thereto on which a bottom surface 10 to be described below is provided may be referred to as a lower side. Also, a direction perpendicular to a vertical direction and along a front surface 20 and a rear surface 30 to be described below is referred to as a left-right direction, a direction perpendicular to the vertical direction and along a left side surface 40 and a right side surface 50 to be described below is referred to as a front-rear direction, and a direction along a circumferential edge of the bottom surface may be referred to as a circumferential direction.

The square-bottomed packaging bag 1 includes the rectangular bottom surface 10, four side surfaces of the front surface 20, the rear surface 30, the left side surface 40, and the right side surface 50, standing from four sides of the bottom surface 10, four side seal portions 21 at four corners between the side surfaces, two bottom seal portions 22 between the bottom surface 10 and the left side surface 40 and between the bottom surface 10 and the right side surface 50, and two butt-joint seal portions 43 and 53 on the left side surface 40 and the right side surface 50.

Both the front surface 20 and the rear surface 30 are rectangular and stand from long sides of the bottom surface 10 in the vertical direction (including a substantially vertical direction; the same applies hereinafter). The front surface 20 and the rear surface 30 share lower sides thereof with the long sides of the bottom surface 10 and are continuous with the bottom surface 10. That is, when the film is folded along the long sides of the bottoms surface 10 (lower sides of the front surface 20 and the rear surface 30), the front surface 20 is continuous with the bottom surface 10, and the rear surface 30 is continuous with the bottom surface 10.

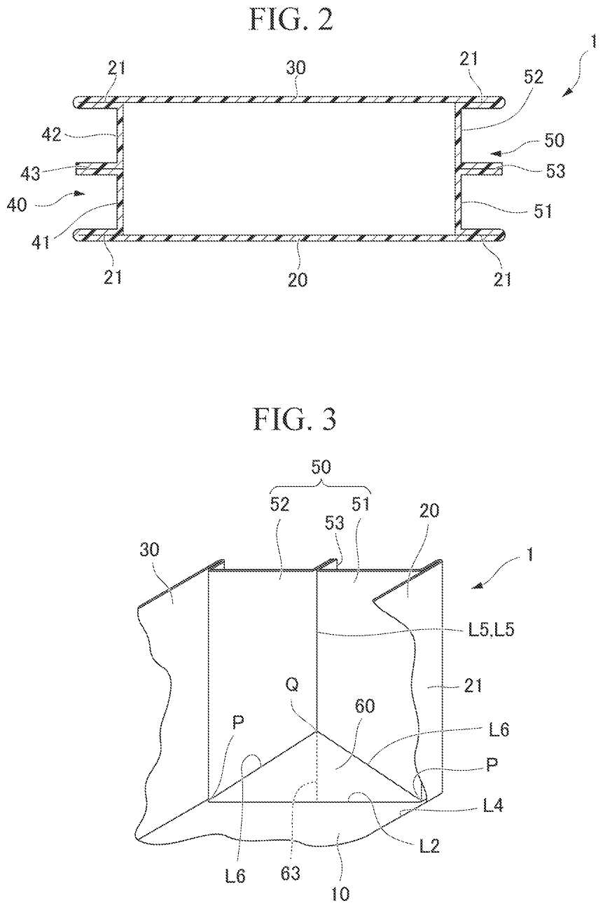

FIG. 2 is a schematic cross-sectional view along line I-I of FIG. 1.

The left side surface 40 and the right side surface 50 are both rectangular, connect the front surface 20 and the rear surface 30, and stand from short sides of the bottom surface 10 in the vertical direction. Specifically, the film folded back in parallel with the short sides is joined together by a constant width on an outward side of the short side of the rectangular bottom surface 10 in the left-right direction, and thereby bottom seal portions 22 are formed on the outward side of the short side of the bottom surface 10, and the left side surface 40 and the right side surface 50 stand from inner edges of the bottom seal portion 22 in the vertical direction. The inner edge of the bottom seal portions 22 and the short sides of the bottom surface 10 overlap each other.

The bottom seal portions 22 extend in the same plane as the bottom surface 10, and the bottom seal portions 22 and the bottom surface 10 serve as a placement surface of the square-bottomed packaging bag 1. In other words, what can be seen when the square-bottomed packaging bag 1 is viewed from the bottom is the bottom surface 10 and the two bottom seal portions 22 adjacent to the bottom surface 10. The bottom surface 10 and the bottom seal portions 22 are directly continuous, but the bottom seal portions 22 are continuous with first regions 41 and 51 and with second regions 42 and 52 via folded portions 60 to be described below.

As illustrated in FIG. 2, the left side surface 40 includes the first region 41 on a side close to the front surface 20 and the second region 42 on a side close to the rear surface 30. Similarly, the right side surface 50 includes the first region 51 on a side close to the front surface 20 and the second region 52 on a side close to the rear surface 30. The first regions 41 and 51 are each continuous with the front surface 20 via side seal portions 21 joined by a constant width. Thereby, the side seal portions 21 adjacent to the front surface 20 are formed on both outward sides of the front surface 20 in the left-right direction. Similarly, the second regions 42 and 52 are each continuous with the rear surface 30 via side seal portions 21 joined by a constant width, and the side seal portions 21 adjacent to the rear surface 30 are formed on both outward sides of the rear surface 30 in the left-right direction. The side seal portions 21 and the bottom seal portions 22 serve as continuous seal portions extending from the front surface 20 to the rear surface 30 via the bottom surface 10.

The first region 41 and the second region 42 are integrated to form the left side surface 40 by a side-surface-joining portion in which a rear surface side of the first region 41 and a front surface side of the second region 42 are integrally joined by the butt-joint seal portion 43 extending at a central portion of the side surface in a width direction of the left side surface 40. That is, inner surfaces of the rear surface side of the first region 41 and the front surface side of the second region 42 are integrally joined to face each other, and thereby the side-surface-joining portion is formed to protrude outward from the square-bottomed packaging bag. In the butt-joint seal portion 43, the inner surface of the first region 41 and the inner surface of the second region 42 are joined. In the same way, a side-surface-joining portion including the butt-joint seal portion 53 is also formed on the right side surface 50, and the first region 51 and the second region 52 form the right side surface 50. That is, the butt-joint seal portion 43 is formed on the left side surface 40 as the side-surface-joining portion, and the butt-joint seal portion 53 is formed on the right side surface 50 as the side-surface-joining portion. Also, sandwiched portions 63 to be described below are provided at portions of the butt-joint seal portions close to the bottom seal portions 22.

FIG. 3 is a partial perspective view illustrating the inside of the square-bottomed packaging bag 1. The folded portions 60 are formed on inner sides of the left side surface 40 and the right side surface 50 (only the right side surface 50 side is illustrated in FIG. 3). The folded portion 60 is continuous with the bottom surface 10 via the bottom seal portion 22. When viewed from the inside of the square-bottomed packaging bag 1, the folded portion 60 is a triangle (more accurately, an isosceles right triangle) having one side that overlaps the short side of the bottom surface 10. On a back side of the triangle, a region (the sandwiched portion 63 to be described below) continuous with the folded portion 60 is positioned along a perpendicular line drawn from an apex of the triangle to an opposite side which is the side overlapping the short side of the bottom surface 10 and is sandwiched by the butt-joint seal portion 43 or 53, and thereby the folded portions 60 are connected to the side surfaces.

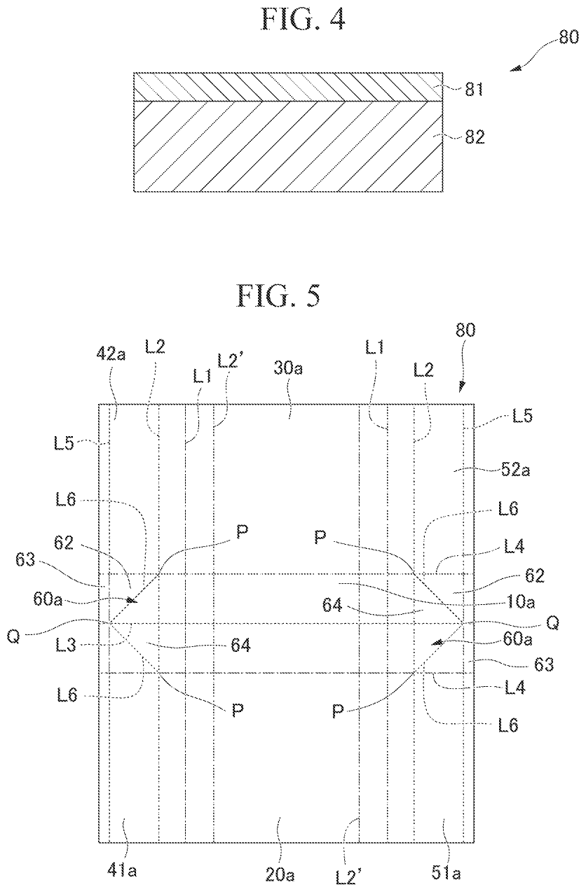

FIG. 4 illustrates a schematic cross-sectional view of a film used for manufacture. As illustrated in FIG. 4, the film 80 includes a base material layer 81 configured to form an outer layer of the square-bottomed packaging bag 1, and a heat fusion layer 82 formed on one surface of the base material layer 81 and configured to form an inner layer of the square-bottomed packaging bag 1.

The base material layer 81 is a layer that defines basic physical properties of the film 80, and a known film or resin such as a biaxially oriented film including polyethylene terephthalate, polypropylene, polyamide, or the like which is excellent in printability, heat resistance, and strength can be used for the base material layer 81 considering an application or the like of the square-bottomed packaging bag 1. Also, a vapor deposition film in which a metal such as aluminum or a metal oxide such as aluminum oxide or silicon oxide is vapor-deposited on the above-described films may be used as the base material layer 81 of a film that exhibits a gas barrier function for blocking oxygen and water vapor. The heat fusion layer 82 is formed of a known heat-fusible film or resin such as unstretched films including polypropylene, or polyethylene such as low-density polyethylene, linear low-density polyethylene, or the like, or resins of these polymers.

The film 80 can be formed by a known method such as a coextrusion method of forming films by extruding a resin material of each layer, a dry lamination method of laminating films constituting each layer together using an adhesive or the like, an extrusion lamination method of extruding a hot-melt resin serving as the heat fusion layer 82 on the base material layer 81, or the like. Further, a functional layer exhibiting a desired function such as a light-shielding layer or a gas barrier layer may be further provided between the base material layer 81 and the heat fusion layer 82. As the functional layer, for example, the above-described vapor deposition film or a metal foil such as aluminum can be used. Also, as a layer exhibiting impact resistance, a film such as polyamide can be used.

FIG. 5 illustrates a developed view of the square-bottomed packaging bag 1. FIG. 5 corresponds to a state in which the heat fusion layer 82 of the film 80 is positioned on the front side of the paper surface. In FIG. 5, when viewed from a surface on the heat fusion layer 82 side, a broken line indicates a mountain fold line and a one-dot dashed line indicates a valley fold line. Further, in the following description, mountain folds and valley folds also refer to mountain folds and valley folds when viewed from the surface of the heat fusion layer 82 side unless otherwise specified. Also, a two-dot dashed line is not a fold line but is a line that represents a position at which a mountain fold line is present after the film is valley-folded or mountain-folded, and this will be described below.

As illustrated in FIG. 5, in the developed view of the square-bottomed packaging bag 1, in one piece of the rectangular film 80, regions are positioned adjacent to each other or not adjacent to each other roughly as follows, the regions being configured to form surfaces of the bottom surface 10, the front surface 20, the rear surface 30, the left side surface 40 and the right side surface 50, seal portions of the side seal portions 21, the bottom seal portions 22, and the butt-joint seal portions 43 and 53, the folded portions 60 and the sandwiched portions 63.

First, a region 10a to become the bottom surface 10 is positioned at a central portion, and regions 20a and 30a to become the front surface 20 and the rear surface 30 are positioned with the region 10a sandwiched therebetween. Further, regions 41a and 51a to become the first regions 41 and 51 forming the front surface side of the side surfaces are respectively positioned on the left and right of the region 20a, and regions 42a and 52a to become the second regions 42 and 52 forming the rear surface side of the side surfaces are respectively positioned on the left and right of the region 30a. At portions sandwiched between the above-described regions, regions to become the side seal portions 21 and the bottom seal portions 22 are positioned, and regions 60a that are folded into the above-described folded portions 60 when the square-bottomed packaging bag 1 is assembled are positioned at regions positioned on the left and right of the region 10a. At left and right ends of the above-described regions and at left and right ends of the film 80, regions that are parts of the regions 41a, 42a, 51a, and 52a and to become the butt-joint seal portions 43 and 53 are positioned. Also, at left and right ends of the above-described regions and at left and right ends of the film 80, regions that have a narrow width extending in the vertical direction and to become the sandwiched portions 63 are positioned at portions continuous with the regions 60a. As described above, in the square-bottomed packaging bag of the present invention, since the surfaces, the seal portions, and the like are formed from the regions of the one-piece rectangular film, no waste of scraps of the film is generated.

A method of manufacturing the square-bottomed packaging bag of the first embodiment will be described.

The method of manufacturing a square-bottomed packaging bag according to the first embodiment includes a side seal portion and bottom seal portion forming step by folding the one-piece rectangular film such that parts of the one-piece rectangular film overlap each other, and then heating and pressing it, a bottom surface folding step of forming the bottom surface of the film folded approximately in half in which the folded portions are folded in an inverted V shape, and a side surface forming step of forming the side surfaces by joining ends of the film folded approximately in half together, and, when contents are sequentially filled after the square-bottomed packaging bag is manufactured, also includes a three-dimensionalization step of opening the square-bottomed packaging bag in a folded state, and forming a quadrangular bottom surface. Hereinafter, steps of forming surfaces, seal portions, and the like from the regions will be described by describing each step of the method of manufacturing the square-bottomed packaging bag of the first embodiment in detail.

### Step of Forming Side Seal Portion and Bottom Seal Portion

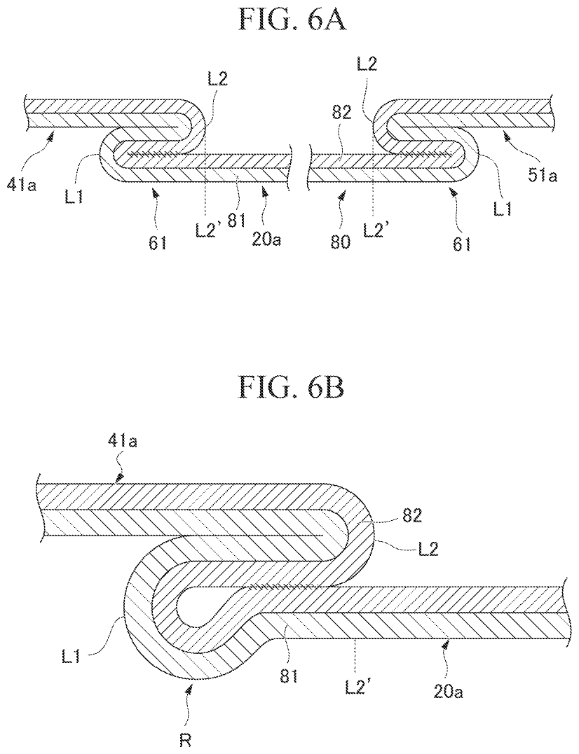

First, as illustrated in FIG. 5, along two boundary lines L1, the rectangular film 80 is valley-folded until the heat fusion layer 82 thereof comes into contact with itself when viewed from the heat fusion layer 82 side, and next, along folded-back lines L2, which are in parallel with the boundary lines L1 and provided on outward sides of the boundary lines L1 in the left-right direction, the rectangular film 80 is mountain-folded until the base material layer 81 thereof comes into contact with itself. As illustrated in FIG. 6A, folded-back portions 61 folded back in a zigzag shape are formed at two places of the film 80 by valley-folding and mountain-folding the rectangular film 80. In each of the folded-back portions 61, there is one portion at which the heat fusion layer 82 faces itself. Next, when predetermined heat and pressure are applied to each folded-back portion 61, the portions of the heat fusion layers 82 facing each other are fused to each other, and thereby the side seal portion and bottom seal portion forming step is completed. Here, lines that are ascertained as positions at which the folded-back lines L2 that have been mountain-folded are in contact with the film 80 are boundary lines L2′. The boundary lines L2′ are boundary lines of the regions 20a, 10a, and 30a, and seal portions having a constant width are formed on both sides of these regions 20a, 10a, and 30a in the left-right direction. In FIG. 6A, the heat-fused portion is illustrated by short-hatched lines. In the present embodiment, these seal portions are the four side seal portions 21 and the two bottom seal portions 22.

Widths of the side seal portions 21 and the bottom seal portions 22 can be appropriately set but are preferably, for example, about 3.0 mm to 15.0 mm. Also, widths of the side seal portions 21 and the bottom seal portions 22 on the left and right may each be different, but it is preferable that the left and right seal portions have the same width in order to improve an external appearance. The number of times the film 80 is folded back in the folded-back portion 61 may be an even number of times, but the above-described example (i.e., folded two times) is most convenient.

Further, sealing modes of the side seal portions 21 and the bottom seal portion 22 can be appropriately changed. For example, when a non-joining region R is made only in the vicinity of the boundary line L1 in the portions of the heat fusion layer 82 facing each other as illustrated in FIG. 6B, portions of the boundary lines L1 become soft in the side seal portions of the completed square-bottomed packaging bag. As a result, when the square-bottomed packaging bag is gripped, a situation in which the portions of the boundary lines L1 strongly hit the hand and cause a feeling of discomfort can be suitably prevented.

### Bottom Surface Folding Step

The bottom surface folding step is a step in which the film 80 on which the side seal portions 21 and the bottom seal portions 22 are formed is mountain-folded at a first fold line L3 such that the film 80 is folded in half in a direction perpendicular to the boundary line L1 and is valley-folded at two second fold lines L4 parallel to the first fold line L3 and positioned equidistant from the first fold line L3.

Due to the bottom surface folding step, portions of the folded-back portions 61 sealed by a constant width sandwiched between the two second fold lines L4 become the bottom seal portions 22, and portions other than these portions of the folded-back portions 61 become the side seal portions 21.

A portion surrounded by the two boundary lines L2′ and the two second fold lines L4 is the region 10a to become the bottom surface 10. One of the two second fold lines L4 sandwiched between the two boundary lines L2′ becomes the long side of the bottom surface 10 and the lower side of the front surface 20. Also, the other of the two second fold lines L4 sandwiched between the two boundary lines L2′ is the long side of the bottom surface 10 and the lower side of the rear surface 30. Of the two boundary lines L2′, portions sandwiched between the two second fold lines L4 become the short sides of the bottom surface 10.

Between the two boundary lines L2′, regions continuous with the region 10a via the second fold lines L4 are the region 20a and the region 30a to become the front surface 20 and the rear surface 30.

The regions 60a including the folded portions 60 are included in regions which are provided at the left and right sides of the region 10a and defined by boundaries which are the folded-back line L2 and the two second fold lines L4.

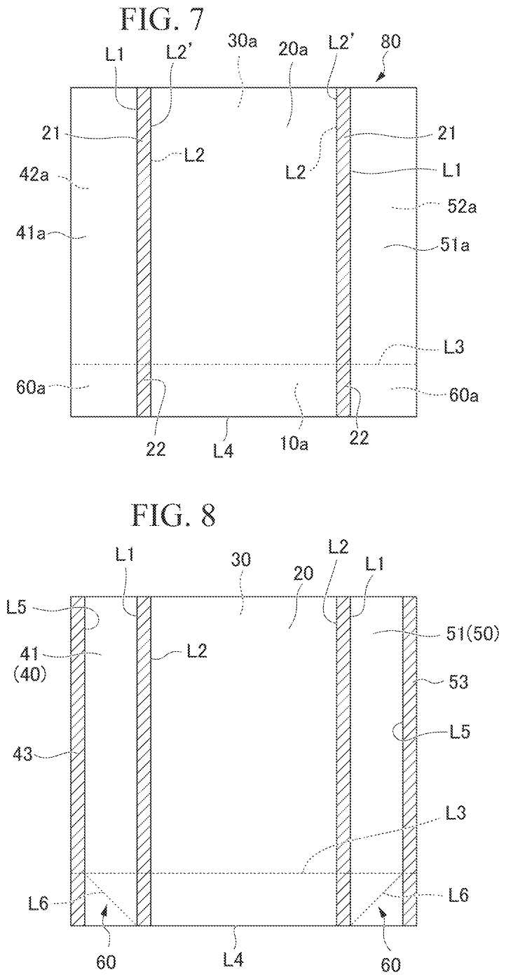

Due to the bottom surface folding step, as illustrated in FIG. 7, the film 80 becomes a flat state in which the region 20a and the region 30a overlap each other over substantially the entire area, and the region 10a folded in an inverted V shape with the first fold line L3 as a top portion is positioned between the region 20a and the region 30a.

When the region 10a is folded in an inverted V shape, the bottom seal portions 22 positioned on both sides of the region 10a in the left-right direction are also folded in the inverted V shape. Further, in the two side seal portions 21, the region 41a and the region 42a overlap each other, and the region 51a and the region 52a overlap each other. Also, in the two side seal portions 21, the regions 60a are folded in an inverted V shape and enter between the region 41a and the region 42a and between the region 51a and the region 52a to be sandwiched therebetween. That is, the region 41a and the region 42a overlap each other in one side seal portion 21, and the region 51a and the region 52a overlap each other in the other side seal portion 21.

### Side Surface Forming Step

When the bottom surface folding step is completed, the region 41a and the region 42a, and the region 51a and the region 52a each have a positional relationship in which the heat fusion layers 82 thereof face each other. In the side surface forming step, the region 41a, the region 42a, the region 51a and the region 52a are heated and pressed to have desired widths at both ends of the film 80 in the left-right direction. Thereby, the heat fusion layers 82 of the region 41a and the region 42a are joined to form the butt-joint seal portion 43, and the heat fusion layers 82 of the region 51a and the region 52a are joined to form the butt-joint seal portion 53 as illustrated in FIG. 8. As a result, the region 41a and the region 42a are connected to form the left side surface 40, the region 51a and the region 52a are connected to form the right side surface 50, and inner edges L5 of the butt-joint seal portions 43 and 53 are formed.

Here, the butt-joint seal portions 43 and 53 are formed at positions such that distances between the inner edges L5 and the folded-back lines L2 are equal to distances between the second fold lines L4 and the first fold line L3. When these distances are made equal, the length of the short side of the bottom surface 10 (this length is twice the distance between the second fold lines L4 and the first fold line L3) and the width of the side surface portion (this width is twice the distance between the inner edges L5 and the folded-back lines L2) in the front-rear direction in the square-bottomed packaging bag are made equal. That is, this is because, in the three-dimensionalization step to be described below, when a position of the inner edge L5 is appropriately determined, the front surface, the rear surface, and the left and right side surfaces stand in the vertical direction from sides of the bottom surface of the squared bottom to form the square-bottomed packaging bag with an excellent external appearance in which an area of the bottom surface and an area of the opening are substantially equal.

In the steps so far, since the square-bottomed packaging bag is completed although it is in a folded state in which the front surface 20 and the rear surface 30 are in close contact with each other, names of portions in the completed square-bottomed packaging bag 1 illustrated in FIGS. 1 to 3 and the like will be described below.

At this time, the first regions 41 and 51 are not directly sealed with the second regions 42 and 52 respectively on a lower side of the butt-joint seal portions 43 and 53. Then, the two sandwiched portions 63 (see FIG. 1), which have respectively entered between the first region 41 and the second region 42 and between the first region 51 and the second region 52, are respectively joined to the heat fusion layers 82 of the first region 41 and the second region 42, and the heat fusion layers 82 of the first region 51 and the second region 52 by heat fusion to be completely sealed in a fluid-tight manner, and thereby fluid-tightness of the completed square-bottomed packaging bag is secured. That is, the first region 41 and the second region 42 are not directly sealed on the lower side of the butt-joint seal portion 43, and the heat fusion layer 82 of the sandwiched portion 63 that has entered between the first region 41 and the second region 42 is joined to the heat fusion layers 82 of the first region 41 and the second region 42 by heat fusion. Also, the first region 51 and the second region 52 are not directly sealed on the lower side of the butt-joint seal portion 53, and the heat fusion layer 82 of the sandwiched portion 63 that has entered between the first region 51 and the second region 52 is joined to the heat fusion layers 82 of the first region 51 and the second region 52 by heat fusion. In the present embodiment, the regions including the heat fusion layers 82 of the first region 41 and 51, the heat fusion layers 82 of the second region 42 and 52, and the heat fusion layers 82 of the sandwiched portions 63 are referred to as the butt-joint seal portions 43 and 53, which extend from the upper end to the lower end of the square-bottomed packaging bag 1.

When the side surface forming step is completed, a basic shape of the square-bottomed packaging bag of the present embodiment in which portions other than the upper opening are sealed is completed.

### Three-Dimensionalization Step

The three-dimensionalization step is a step in which the front surface 20 and the rear surface 30, which are the region 20a and the regions 30a overlapped each other in the bottom surface folding step, are separated from each other, the bottom surface 10 that has been folded is spread to a flat shape while the left and right butt-joint seal portions 43 and 53 are brought close to each other such that the left side surface 40 and the right side surface 50 enter gaps between the front surface 20 and the rear surface 30 which have been formed due to the separation described above, and the folded portion 60 is made to stand perpendicular to the bottom surface 10 to form the square-bottomed packaging bag 1 having an upper opening.

This step will be described in more detail. The folded portion 60 is formed from the region 60a by being mountain-folded along hypotenuses L6 connecting intersection points P between the folded-back line L2 and the second fold lines L4 and an intersection point Q between the first fold line L3 and the inner edge L5 of one of the butt-joint seal portions 43 and 53. A triangular region 64 surrounded by the folded-back line L2, the first fold line L3, and the hypotenuse L6, and a triangular region 62 surrounded by the second fold line L4, the inner edge L5, and the hypotenuse L6 are mountain-folded along the hypotenuses L6 such that the base material layers 81 thereof face each other. Due to the formation of the folded portion 60 and the mountain fold of the triangular regions 64 and 62 along the hypotenuses L6, the two regions 64 adjacent to each other with a boundary of the first fold line L3 in common (adjacent to each other with the first fold line L3 as a boundary line) stand perpendicular to the bottom surface 10, and the two regions 62 are positioned in the rear of the two regions 64. Also, in the inner edge L5 of the butt-joint seal portion, a portion sandwiched between the two second fold lines L4 is valley-folded, and the other portion is mountain-folded. The left side surface 40 and the right side surface 50 enter the gaps between the front surface 20 and the rear surface 30, and lower ends of the butt-joint seal portions 43 and 53 are positioned on the bottom seal portions 22. In the three-dimensionalization step, steps including these steps described above in detail proceed sequentially or simultaneously.

When the three-dimensionalization step is finished, the left and right side surfaces become flat, and, among the lines partitioning the first regions 41 and 51 and the second regions 42 and 52, the second fold lines L4 become the lower sides of the left and right side surfaces. The folded portion 60 that is seen as a triangle from the inside of the square-bottomed packaging bag 1 illustrated in FIG. 3 stands in the vertical direction from the bottom surface 10. The folded portion 60 is a triangle formed by the lower side that is part of the folded-back line L2 (a portion of the folded-back line L2 that overlaps the short side of the bottom surface 10) and the two hypotenuses L6 connecting the intersection points P between the folded-back line L2 and the second fold lines L4 and the intersection point Q between the inner edge L5 of one of the butt-joint seal portions 43 and 53 and the first fold line L3, and the folded portion 60 includes the two regions 64. In this triangle, the region between the intersection points P and P on the folded-back line L2 is the bottom side, and the intersection point Q is the apex.

The folded portion 60 and the bottom seal portion 22 are continuous with the folded-back line L2 as a common side partitioning the bottom seal portion 22, the folded portion 60 is continuous with the sandwiched portion 63 via the two regions 62 in the rear of the folded portion 60, and the sandwiched portion 63 is coupled to one of the left side surface 40 and the right side surface 50 by being sandwiched in one of the butt-joint seal portions 43 and 53 with the intersection point Q as an upper end. Further, since the folded portion 60 is a triangle having the bottom side on the bottom surface 10 with the intersection point Q as the apex and, the side surface having one of the butt-joint seal portions 43 and 53 and the two regions 62 are present on the back surface of the folded portion 60, and there are three pieces of films on a lower portion of the side surface on which the folded portion 60 is present, a bottom portion of the square-bottomed packaging bag 1 is suitably reinforced, the bottom portion is prevented from being mountain-folded along the first fold line L3 again, a state of the squared bottom is maintained, and at the same time, an overall shape of the bag is also stably maintained.

In a state in which the folded portion 60 stands, the heat fusion layers 82 of the two regions 62 positioned on the back side of the triangle which can be seen from the inside of the square-bottomed packaging bag 1 in the folded portion 60 face the heat fusion layer 82 serving as an inner surface of one of the left side surface 40 and the right side surface 50. When the heat fusion layer 82 of one of the left side surface 40 and the right side surface 50 is joined to the heat fusion layers 82 of the regions 62 by adhesion or heat fusion, the folded portion 60 is completely integrated with one of the left side surface 40 and right side surface 50, and the shape of the square-bottomed packaging bag can be maintained more stably. The joining of the regions 62 and one of the left side surface 40 and the right side surface 50 by adhesion, heat fusion, or the like may be performed for only the portions along the hypotenuses L6 or may be performed for the entire surface. When at least the portions along the hypotenuses L6 are joined, since the contents filled in the square-bottomed packaging bag 1 do not enter between the regions 62 and each of the left side surface 40 and the right side surface 50, this is preferable. Also, this joining is easily performed in the side surface forming step before the three-dimensionalization step, and when the joining is performed along the hypotenuses L6 beforehand, the mountain fold along the hypotenuses L6 is facilitated in the three-dimensionalization step, and this is preferable in that the folded portion 60 can be easily formed. Further, the joining along the hypotenuses L6 in this case is preferably performed along an outer side of the sides of the triangular folded portion 60.

FIGS. 1 and 3 illustrate positions of the boundary line L1, the folded-back line L2, the second fold line L4, and the like in the completed square-bottomed packaging bag 1.

Further, when desired contents are filled into the square-bottomed packaging bag 1 from the upper opening and the upper opening is sealed, a packaging body in which the contents are closed or sealed in the square-bottomed packaging bag 1 is completed.

A sealing mode of the upper opening may be appropriately changed according to types and shapes of the contents. For example, when a fluid content is filled, a known spout may be sandwiched in the upper opening and sealed together. When a spout is attached, the spout may be attached in a state in which upper portions of the left side surface 40 and the right side surface 50 are folded toward the inside of the square-bottomed packaging bag 1, and the spout is sandwiched between the front surface 20 and the rear surface 30. Also, the square-bottomed packaging bag may be formed such that it can be resealed after opening by attaching a known zipper and sealing the square-bottomed packaging bag. When a zipper is attached, the zipper may be attached in a state in which the upper portions of the left side surface 40 and the right side surface 50 are pulled out to both sides of the front surface 20 and the rear surface 30 in the left-right direction.

The spout may be attached in a state in which the upper portions of the left side surface 40 and the right side surface 50 are pulled out to both sides in the left-right direction. The upper opening may be sealed by simply sealing it in a state in which the upper portions of the left side surface 40 and the right side surface 50 are pulled out to both sides in the left-right direction or upper portions of the left side surface 40 and the right side surface 50 are folded toward the inside and the left side surface 40 and the right side surface 50 are sandwiched between the front surface 20 and the rear surface 30.

Also, an order of filling and sealing for the square-bottomed packaging bag of the present invention not only includes sealing after filling, but may also include filling after sealing such as filling contents from the spout after sealing by sandwiching the spout.

According to the square-bottomed packaging bag 1 of the present embodiment, the left side surface 40 and the right side surface 50 positioned between the front surface 20 and the rear surface 30 are formed by joining the first region and the second region. As a result, the number of joining portions such as seal portions extending around the bottom surface 10 can be remarkably reduced while the square-bottomed packaging bag 1 can be manufactured from the one-piece film 80.

Therefore, it is possible to suitably suppress the seal portions extending in front of and behind the bottom surface 10 to occur interference or deteriorating an external appearance when a plurality of the square-bottomed packaging bags 1 are displayed, and thus the external appearance of the square-bottomed packaging bag 1 is excellent. Also, when the square-bottomed packaging bag 1 is manufactured from the one-piece film 80, since there is no portion of the one-piece film to be cut and removed, waste of the film piece is not generated during the manufacturing process.

Also, according to the square-bottomed packaging bag 1 of the present embodiment, a surface that serves as the placement surface when it stands on its own is formed only by the bottom surface 10 and the bottom seal portions 22 extending on the same plane as the bottom surface 10. Therefore, in the completed square-bottomed packaging bag 1, the placement surface is formed to be flat from the one-piece film 80. As a result, stability at the time of use is very excellent.

Further, since the side seal portions 21 extend substantially perpendicular to the bottom surface 10 from the vicinity of four vertices of the bottom surface 10 and function as pillars supporting the structure, it is excellent in self-standing property. Therefore, the square-bottomed packaging bag 1 of the present embodiment is easy to fill contents therein and a stable state is maintained even during storage. Further, even when a volume of the contents is smaller than a volume of the square-bottomed packaging bag, an outer shape of the square-bottomed packaging bag is not easily broken.

In addition to the side seal portions 21, since the triangular folded portions 60 when viewed from the inside of the square-bottomed packaging bag is provided inside the lower portions of the left and right side surfaces 40 and 50, deformation to such an extent as to break the shape of the squared bottom does not easily occur even when an external force is applied, and the shape of the lower portion of the square-bottomed packaging bag is stably maintained. Further, since the folded portions 60 are respectively integrated with the left and right side surfaces 40 and 50, the lower shape of the square-bottomed packaging bag is more stably maintained.

Further, since the side seal portions 21 extend on the same plane as the front surface 20 and the rear surface 30, a large display area of the front surface and the rear surface can be secured without causing discomfort. As a result, when the square-bottomed packaging bag is displayed in a store, an appealing effect of the packaging bag to purchasers can be enhanced, and needed information such as ingredients and cautionary statements can be described on the packaging bag and easily seen by users.

In the first embodiment, when the square-bottomed packaging bag is desired to be formed into a more compact shape with an excellent external appearance, the square-bottomed packaging bag may have various shapes in which the folded portions 61 modified as below.

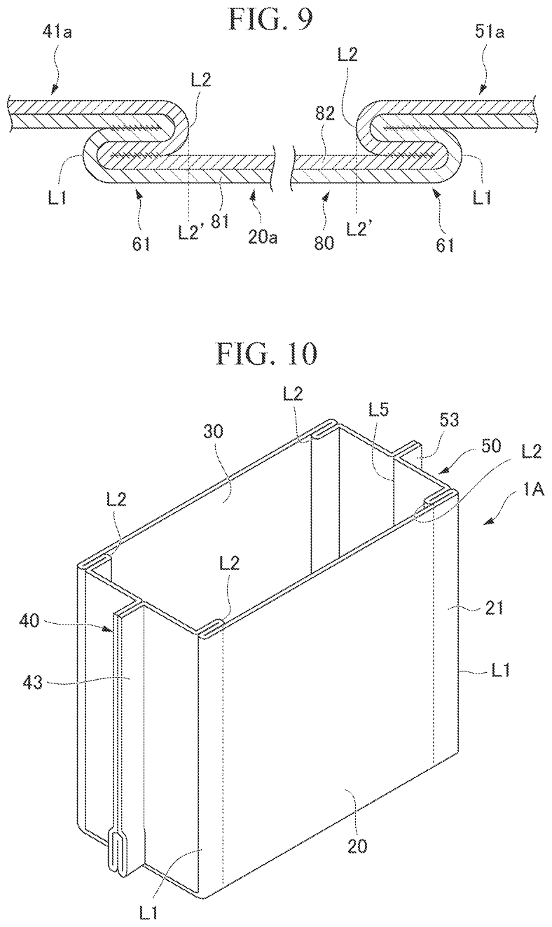

For example, in the folded portion 61, in addition to the joining of the heat fusion layers 82 to each other, the portions of the base material layers 81 facing each other may be further joined to each other as illustrated in FIG. 9. In this case, as in a square-bottomed packaging bag 1A of a modified example illustrated in FIGS. 10 and 11, in a state in which the side seal portions 21 and the bottom seal portions 22 extend along the front surface 20, the rear surface 30, or the bottom surface 10, the side seal portions 21 and the bottom seal portions 22 can be integrated with the respective surfaces. Since the side seal portions 21 and the bottom seal portions 22 do not protrude in the left-right direction of the square-bottomed packaging bag, the square-bottomed packaging bag 1A has a satisfactory external appearance. Also, since the side seal portions 21 formed at four corners of the square-bottomed packaging bag 1A reinforce the front surface 20 and the rear surface 30, a self-standing property is also satisfactory, and the square-bottomed shape can be maintained more stably.

In the square-bottomed packaging bag 1A, the boundary lines L1 after the base material layers 81 of the folded-back portions 61 are joined to each other are positioned at boundary portions of the front surface 20 and the rear surface 30 with the left side surface 40 and the right side surface 50, respectively. As illustrated in FIG. 6B, when a non-joining region is provided in the vicinity of the boundary line L1, the portions of the base material layers 81 facing each other at the non-joining region R may not be joined, or the portions of the base material layers 81 facing each other may be joined according to a width in which the portions of the heat fusion layers 82 facing each other are joined. Further, the base material layers 81 facing each other may be joined over the entire width of the folded-back portion 61. When the base material layers 81 are joined to each other regardless of the presence or absence of the non-joining region, a boundary between a portion in which the base material layers 81 are joined to each other and a portion in which the base material layers 81 are not joined to each other may be used as each of boundary portions of the front surface 20 and the rear surface 30 with the left side surface 40 and the right side surface 50. Alternatively, any position between the above-described boundary and the boundary line L1 may be used as the boundary portion.

When the base material layers 81 are not joined to each other, any position between the folded-back line L2 and the boundary line L1 may be used as the boundary portion. In order to obtain a compact shape with an excellent external appearance, it is preferable to use the boundary lines L1 as the boundary portions. In cases of these modified examples, the hypotenuse L6 of the folded portion 60 extends from an intersection point between the boundary portion and the second fold line L4.

Joining of the base material layers 81 serving as outermost layers to each other can also be performed by a method such as applying an adhesive partially on portions of the base material layers 81 desired to be joined. When the square-bottomed packaging bag is manufactured by using a film having a heat-fusible property as the base material layer 81 or by partially or entirely applying a heat-fusing agent on the base material layer 81, since joining of the base material layers 81 to each other can also be performed by heat sealing, it is convenient.

When a film having the heat-fusible property is used for the base material layer, it is preferable because the base material layers 81 can also be joined to each other at the same time as joining of the heat fusion layers 82 to each other for forming the side seal portions and the bottom seal portions in heat sealing of the side seal portion and bottom seal portion forming step.

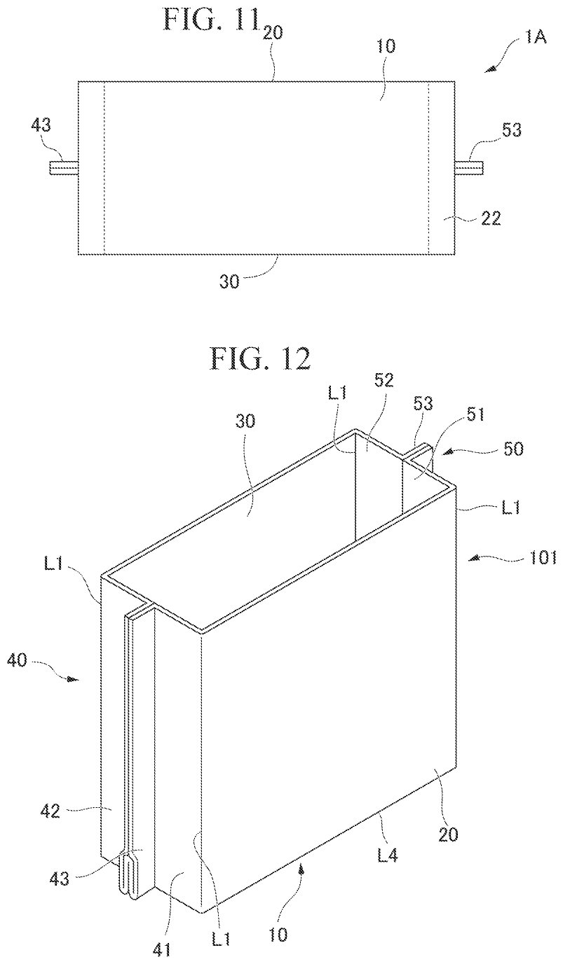

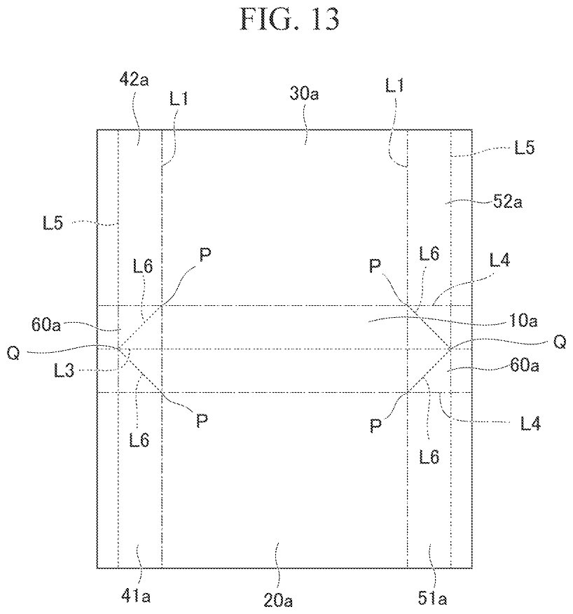

Next, a second embodiment of the present invention will be described with reference to FIGS. 12 and 13. In the following description, the same components as those already described will be denoted by the same reference signs and duplicate description will be omitted.

FIG. 12 illustrates a square-bottomed packaging bag 101 of the present embodiment. The square-bottomed packaging bag 101 is the same as the square-bottomed packaging bag 1 except that it differs from the square-bottomed packaging bag 1 in that it does not have side seal portions and bottom seal portions. That is, in the folded square-bottomed packaging bag 101, first regions 41 and 51 are continuous with a front surface 20, and second regions 42 and 52 are continuous with a rear surface 30.

FIG. 13 illustrates a developed view of the square-bottomed packaging bag 101. Since the square-bottomed packaging bag 101 does not have side seal portions and bottom seal portions, there are no folded-back lines L2. Hypotenuses L6 of a folded portion 60 extend from intersection points of a boundary line L1 and second fold lines L4. Other components of the square-bottomed packaging bag 101 are substantially the same as those in the developed view of the square-bottomed packaging bag 1.

A method of manufacturing the square-bottomed packaging bag 101 of the present embodiment is the same as the method of manufacturing the square-bottomed packaging bag 1 of the first embodiment except that a side seal portion and bottom seal portion forming step is not provided. That is, the square-bottomed packaging bag 101 is completed by sequentially performing a bottom surface folding step and a side surface forming step on the one-piece film 80, and finally performing a three-dimensionalization step.

Like the square-bottomed packaging bag 1 of the first embodiment, the square-bottomed packaging bag 101 of the present embodiment can be manufactured from the one-piece film 80 and has an excellent external appearance.

Since there is no side seal portion in the square-bottomed packaging bag 101, a shape maintaining ability of the square-bottomed packaging bag 101 is slightly inferior to that of the square-bottomed packaging bag 1, but a flexibility of the square-bottomed packaging bag 101 is higher than that of the square-bottomed packaging bag 1. Also, when a film of the same area is used for manufacturing a square-bottomed packaging bag, the square-bottomed packaging bag 101 can have a larger volume than the square-bottomed packaging bag 1. Therefore, a configuration of the present embodiment is more suitable when a volume and flexibility are emphasized.

The manufacturing method according to the square-bottomed packaging bag 101 of the present embodiment is simpler than the manufacturing method according to the first embodiment because the side seal portion and bottom seal portion forming step is not included.

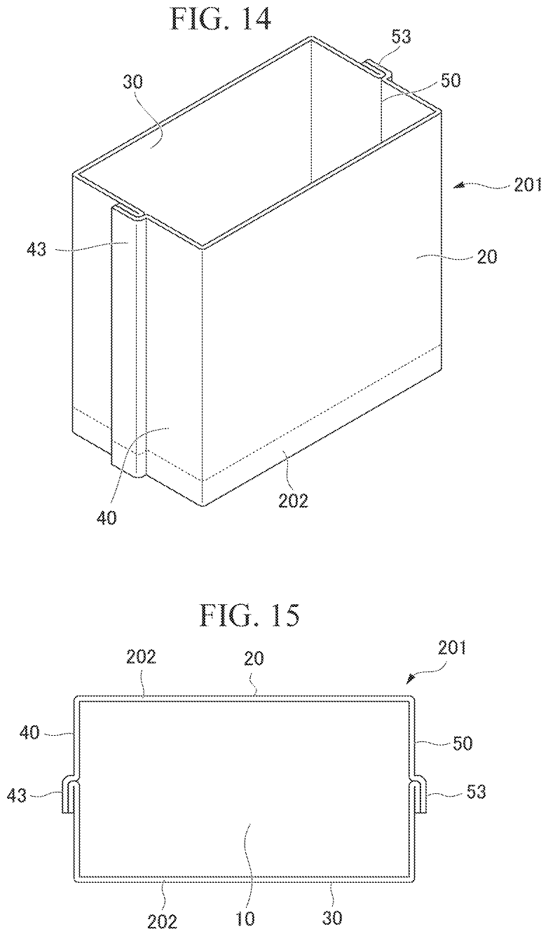

Next, a third embodiment of the present invention will be described with reference to FIGS. 14 and 15.

A square-bottomed packaging bag 201 of the present embodiment illustrated in FIG. 14 has the same configuration as the square-bottomed packaging bag 101, except that it includes a lower end seal portion 202 that goes around a lower end thereof in a circumferential direction, and butt-joint seal portions 43 and 53 are integrated with a left side surface 40 and a right side surface 50, respectively.

FIG. 15 is a view of the square-bottomed packaging bag 201 from a bottom side. The lower end seal portion 202 is formed on a circumferential edge of a bottom surface 10 at the lower end of the square-bottomed packaging bag 201. The lower end seal portion 202 extends from lower ends of a front surface 20, a rear surface 30, the left side surface 40, and a right side surface 50 by a constant width on the same surface as these surfaces and is provided on almost the entire circumference of the square-bottomed packaging bag 201. The square-bottomed packaging bag 201 stands on its own with the lower end seal portion 202 as a foot.

When the square-bottomed packaging bag 201 of the present embodiment is manufactured, after the bottom surface folding step or the side surface forming step in the method of manufacturing the square-bottomed packaging bag 101 of the second embodiment described above, the portions of the heat fusion layers 82 facing each other with a constant width along second fold lines L4 are joined to each other. Thereby, the joining portion with the constant width extending parallel to the second fold lines L4 is the lower end seal portion 202. The constant width of the lower end seal portion 202 is not particularly limited, but is preferably about 1 mm to 10 mm.

As in the embodiments described above, the square-bottomed packaging bag 201 of the present embodiment can also be manufactured from the one-piece film 80 and has an excellent external appearance.

Also, since the lower end seal portion 202 is provided, the self-standing property can be made more satisfactory.

In the square-bottomed packaging bag 201, the butt-joint seal portions 43 and 53 may not be integrated with the left side surface and the right side surface.

Although the first to third embodiments have been described above, various modifications can be made in these embodiments within the scope not hindering the spirit of the present invention.

For example, in the square-bottomed packaging bags of the first embodiment and the second embodiment, the butt-joint seal portions 43 and 53 may be folded down along the left side surface and the right side surface to be integrated with the left side surface and the right side surface. Directions in which both the butt-joint seal portions 43 and 53 are folded down may be the same as each other or opposite to each other on the first regions 41 and 51 on the front surface 20 sides of the side surfaces or on the second regions 42 and 52 on the rear surface 30 sides of the side surfaces. Also, in a case in which a zipper is attached to the upper opening, and upper portions of the left side surface 40 and the right side surface 50 are pulled out to both sides of the front surface 20 and the rear surface 30 in the left-right direction, when the butt-joint seal portions 43 and 53 are folded down in opposite directions to each other, since both the film of the front surface 20 and the first regions 41 and 51 on the front surface side and the film of the rear surface 30 and the second regions 42 and 52 on the rear surface side extend in a well-balanced manner without any one of the films being bent, this configuration is preferable.

In the square-bottomed packaging bag of any of the embodiments, when the butt-joint seal portions are integrated with the left and right side surfaces, the lower sides of the butt-joint seal portions 43 and 53 are each in a state in which four pieces of the films are overlapped due to the sandwiched portion 63 sandwiched therein and thus are not easily bent. Therefore, the heat fusion layers 82 of the regions 62 of the folded portions 60, and the heat fusion layers 82 of the first regions 41 and 51 and the second regions 42 and 52 are joined to each other at least at portions along the hypotenuses L6, and parts of the regions 62 may be cut off while leaving the joined portions. Further, since remaining portions 62a of the regions 62 left without being cut off are joining portions protruding from the planes of the left and right side surfaces, these may be folded down until they come into contact with the base material layers 81 of the left and right side surfaces or the base material layers 81 of the regions 64 of the folded portions 60 facing the regions 62 to be joined and then integrated to be coplanar with each other.

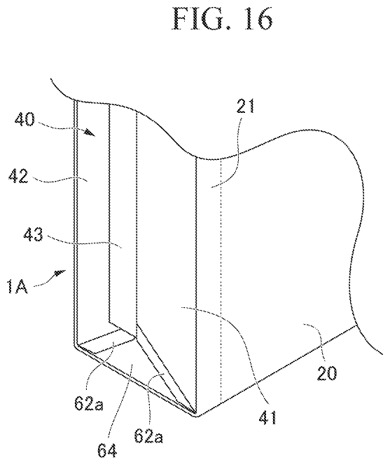

FIG. 16 illustrates an example of the left side surface 40 of the square-bottomed packaging bag 1A integrated by the above-described procedure. In this way, it is not necessary to bend the portion including the sandwiched portion along the side surface, four pieces of the films being overlapped in the portion including the sandwiched portion, and thus the butt-joint seal portion and each of the left and right side surfaces can be easily integrated.

Any of the manufacturing methods according to the above-described embodiments can be suitably applied to an automatic bag making apparatus in which a film is continuously fed out from a raw material roll in which a long film is wound in a roll shape.

When the above-described manufacturing method is applied to an automatic bag making apparatus, each step is performed at a distal end portion of the fed-out film by making a longitudinal direction of the long film coincide with a left-right direction of the square-bottomed packaging bag. In each step, bending is preferably sequentially performed with, for example, various jigs such as a metal bar, and joining is preferably performed by heat sealing using, for example, a heat seal bar.

When the side surface forming step ends, the processed portion is cut off from the raw material roll. By repeating this, the square-bottomed packaging bag can be efficiently mass-produced. When filling equipment is disposed at a downstream portion of the automatic bag making apparatus, contents are filled in the square-bottomed packaging bag while performing the three-dimensionalization step, and thereby mass production of the packaging body in which the contents are filled in the square-bottomed packaging bag can be easily performed.

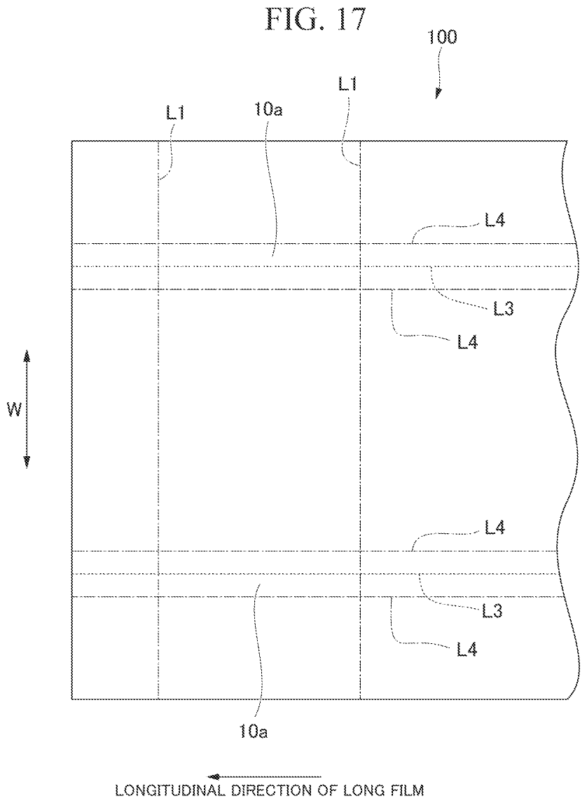

Further, as illustrated in a developed view illustrated in FIG. 17, when a developed area for two square-bottomed packaging bags sharing the boundary line L1 in a width direction W of the long film is set, it is also possible to manufacture two square-bottomed packaging bags at a time. In this case, when the bottom surface folding step is performed by folding the film from both sides of the long film in the width direction W toward a middle portion and then the side surface forming step is performed, a shape in which two square-bottomed packaging bags have upper openings being continuous with each other is obtained. When this shape is cut-off, two square-bottomed packaging bags can be obtained.

Although each embodiment of the present invention has been described above, the technical scope of the present invention is not limited to the contents of the above-described embodiments and the like, and various changes or deletion can be made to the components or a combination of the components can be changed beyond the embodiments within a range not deviating from the spirit of the present invention.

For example, in the above-described example, an example in which the bottom surface is rectangular, and the front surface and the rear surface stand from the long sides of the bottom surface has been described, but it may be configured such that the front surface and the rear surface stand from the short sides of the bottom surface. Also, the bottom surface may be square, or part or all of the four side surfaces may be square.

Also, the mode of the side-surface-joining portion is not limited to the above-described butt-joint seal portion. For example, “envelope joining” that joins an inner surface of one of the first region and the second region and the outer surface of the other of the first region and the second region, or a method in which end portions of the first region and the second region are made to abut each other and joined using another member such as a tape may also be used. However, it is preferable to use the butt-joint seal portion because a part of the sandwiched portion 63 can be sandwiched therein as described above.

In the square-bottomed packaging bag of each embodiment of the present invention, creases may be formed at the boundaries of the front surface and the rear surface with the left side surface and the right side surface. The creases can be formed by a method of inserting a square pillar mandrel or the like into the square-bottomed packaging bag and pressing it with a metal or the like from an outer side of the square-bottomed packaging bag. It is also preferable to form creases to facilitate bending in each manufacturing step of the square-bottomed packaging bag.

Also, in the method of manufacturing a square-bottomed packaging bag of the present invention, the three-dimensionalization step is not indispensable. For example, when the contents are filled in the square-bottomed packaging bag in another place or the like, the manufacture may end in a state in which the square-bottomed packaging bag is flat when the side surface forming step has ended.

### INDUSTRIAL APPLICABILITY

The present disclosure can be utilized for a square-bottomed packaging bag, a packaging body, and a method of manufacturing the square-bottomed packaging bag.

### REFERENCE SIGNS LIST

1, 101, 201 Square-bottomed packaging bag

10 Bottom surface

10a Region to become bottom surface

20 Front surface

20a Region to become front surface

21 Side seal portion

22 Bottom seal portion

30 Rear surface

30a Region to become rear surface

40 Left side surface

41, 51 First region

41a, 51a Region to become first region

42, 52 Second region

42a, 52a Region to become second region

43, 53 Butt-joint seal portion (side-surface-joining portion)

50 Right side surface

80 Film (soft packaging material)

202 Lower end seal portion

L3 First fold line

L4 Second fold line

1. A square-bottomed packaging bag, comprising:
a quadrangular bottom surface;
a front surface and a rear surface standing from two opposite sides of the bottom surface; and
a left side surface and a right side surface connecting the front surface and the rear surface, wherein
the square-bottomed packaging bag is formed by bending a one-piece soft packaging material, and
each of the left side surface and the right side surface includes:
a first region positioned on the front surface side;
a second region positioned on the rear surface side; and
a side-surface-joining portion joining the first region and the second region.

2. The square-bottomed packaging bag according to claim 1, wherein
the front surface and the first region are continuous with each other via one side seal portion in which the front surface and the first region are joined by a constant width, and
the rear surface and the second region are continuous with each other via another side seal portion, in which the rear surface and the second region are joined by a constant width, different from the one side seal portion.

3. The square-bottomed packaging bag according to claim 1, wherein the side-surface-joining portion is a butt-joint seal portion in which inner surfaces of the first region and the second region are joined to each other.

4. The square-bottomed packaging bag according to claim 1, further comprising, on a circumferential edge of the bottom surface, a lower end seal portion which goes along lower ends of the front surface, the left side surface, the rear surface, and the right side surface in a circumferential direction.

5. A packaging body comprising:
the square-bottomed packaging bag according to claim 1; and
contents filled inside the square-bottomed packaging bag.

6. A method of manufacturing a square-bottomed packaging bag, comprising:
a bottom surface folding step of forming a flat state in which a region to become a bottom surface folded in an inverted V shape is positioned between a region to become a front surface and a region to become a rear surface by mountain-folding a one-piece soft packaging material along a first fold line such that the soft packaging material is folded in half and valley-folding the soft packaging material along two second fold lines that are parallel to the first fold line and positioned equidistant from the first fold line; and
a side surface forming step of joining regions to become first regions positioned on two sides of the region to become the front surface to regions to become second regions positioned on two sides of the region to become the rear surface.

7. The method of manufacturing a square-bottomed packaging bag according to claim 6, further comprising, before the bottom surface folding step, a side seal portion and bottom seal portion forming step in which folded-back portions are formed on outward sides of boundary lines in a left-right direction, the boundary lines being positioned between the region to become the front surface and the regions to become the first regions, and between the region to become the rear surface and the regions to become the second regions, by valley-folding the soft packaging material along the boundary lines and by mountain-folding the soft packaging material along folded-back lines substantially parallel to the boundary lines, and side seal portions and bottom seal portions are formed on two sides in the left-right direction of the region to become the front surface and the region to become the rear surface by joining heat fusion layers of each of the folded-back portions.
